(19) United States
(12) Patent Application Publication
(10) Pub. No.: US 2009/0312031 A1
(43) Pub. Date: Dec. 17, 2009

(54) MANAGING EVENT GENERATED OVERLOAD OF A COMMUNICATION NETWORK

(75) Inventors: John M. Harris, Glenview, IL (US); Murali Ranganathan, Phoenix, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/139,531

(22) Filed: Jun. 16, 2008

(51) Int. Cl. H04Q 7/20

(52) U.S. Cl. 455/453; 455/452.1

(57) ABSTRACT

The present invention provides a system and method for managing localized, event-generated overload of a communication network. A first step (400) includes receiving input indicative of a status change of an event in a sports stadium. A next step (402) includes generating an output to the communication network indicating that loading of the communication could be increasing in response to the status change. A next step (404) includes predicting an increased load due to the status change and comparing (406) this against a threshold. A next step (408) includes modifying the services available in geographic proximity to the event for a predetermined period in order to accommodate the increased load due to the status change.

### FIELD OF THE INVENTION

The field of the invention relates communication networks, and in particular to, a system and method for managing event-generated overload in a communication network.

### BACKGROUND OF THE INVENTION

Large groups of people within a small geographic location (e.g. fans at a sporting event in a stadium) cause severe communication demand spikes at particular times, such as when their team scores. These large swings in demand are very difficult to accommodate for an operator of a communication network without service disruption.

One solution is to bring in enough extra infrastructure equipment to accommodate any possible peak in demand. Of course this is an expensive proposition, and it is a waste of resources as the demand usually peaks for very short periods, and at any other times all that added capacity is wasted. Moreover, it is very difficult and time consuming to connect temporary communication equipment, and making new network connections may actually disrupt the existing network. Another solution is to do nothing, which results in many blocked or dropped calls, which results in an unsatisfactory experience for the user.

Other possible solutions can be difficult to implement, particularly in GSM communication networks. For example, within a GSM network it is not possible to convert ongoing voice calls to half rate voice calls. In addition, this would typically require a GSM switch change. Even if half rate voice calls could be used at all times during an event with possible demand spikes, resulting in higher effective call capacity, this would result in lower voice quality which would reflect badly on the user experience.

Another solution would be to convert voice calls to lower bit rate instant (text) messaging calls, or convert higher bit rate multimedia or video calls to audio only. Even if there is no ongoing call, it takes a significant time to convert GSM voice channels to text messaging channels. Similarly, it is awkward in GSM to redirect an ongoing video communication to audio only. Moreover, such conversion wastes capacity waiting for completion, particularly if the conversion is initiated after loading has spiked. In any case, the GSM system does not provide a warning to users before call is placed about service availability or a change from voice to IM or video to audio, for example, which further disrupts the user experience.

As a consequence of the above-mentioned problems, the user experience in such above situations is undesirable, and it would be advantageous to find a solution to alleviate the above problems.

### BRIEF DESCRIPTION OF THE DRAWINGS

FIG. 1 is a block diagram of a system, in accordance with the present invention;

FIG. 2 is an illustration of correlation between a specific game's event change and communication traffic loading;

FIG. 3 is a flow diagram of a method in accordance with the present invention.

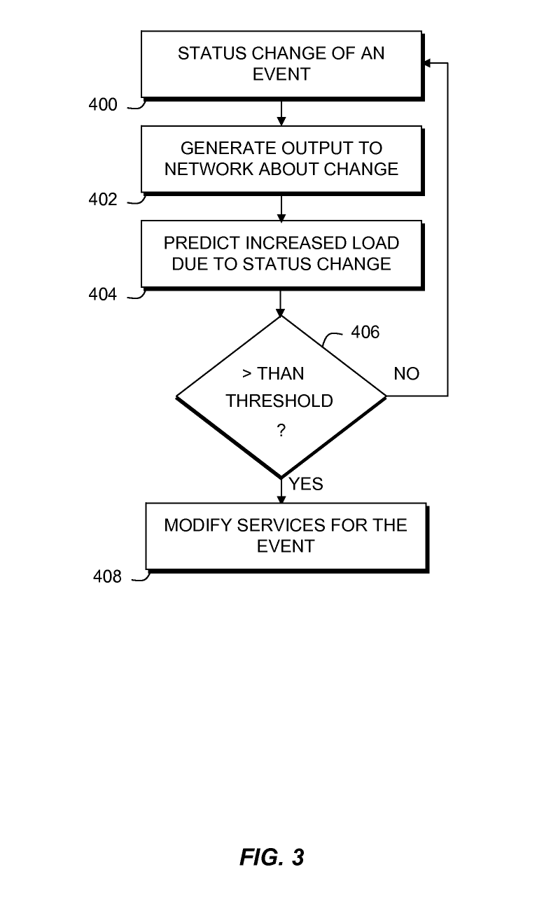

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

The present invention provides a method and system for managing localized event generated overload of a communication network. A technique is used to predict when there is going to be a spike in demand, and subsequently limit high bit rate services during such demand peak to provide suitable communication services to the most people.

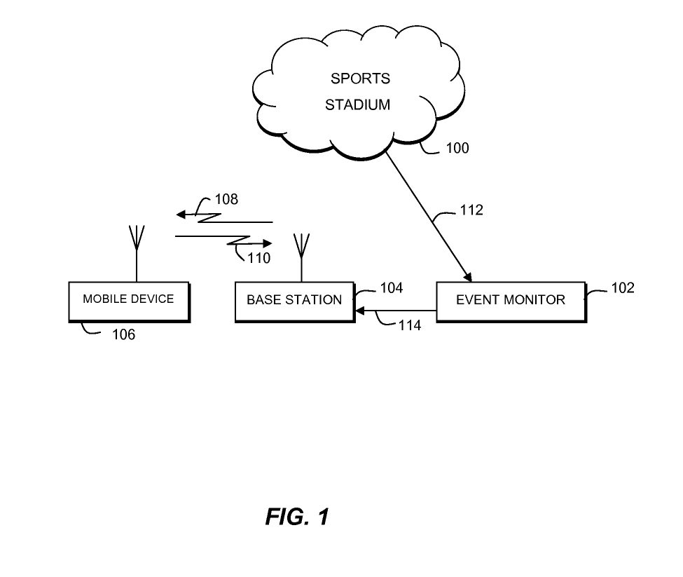

Referring to FIG. 1, a system is shown that includes an event monitor 102 that monitors an event happening in a localized geographic area, such as a sports stadium 100, or other venue. The event monitor is able to communicate with a communication network, that can include at least one base station 104 serving the area of the event (e.g. the sports stadium 100) and a plurality of mobile devices 106 served by each base station 104.

The event monitor 102 is operable to receive input 112 indicating a status change of an event and generate an output 114 to the communication network indicating that loading of the communication will be increasing in response to the status change. In the example of a sporting event, a status change for the sporting event may involve: a change of the current score of a game, scheduled timeouts (e.g. half time) as well as unscheduled (official) timeouts within the game, an overall increase of noise level within the stadium, a change in possession of the ball, and a change in where ball is located, for example.

Specifically, the event monitor can be an internet-enabled device that receives input from game statistics and increased noise level within the stadium. Game statistics can include the current score of the game, a number of scores within a short period, or a difference between the number of goals scored by each team (or when the game score is particularly close within the two teams). The statistics can also include the timing of half time & timeouts within the game (determined in real time but can also be determined by monitoring the number of timeouts left for each team, or potentially the game clock, e.g. if the clock stops, a timeout of some sort or foul has occurred. This can depend on the game clock, where the actual end of the game and the end of the half time are somewhat dynamically determined based on the number of teams stoppages. In this sense the cellular infrastructure could anticipate when these events will occur, and then could provision capacity appropriately. Additionally after the game, the system could automatically start provisioning neighboring cells based on anticipated need as everyone leaves the game. In addition, to the above statistic, the present invention conceivably could be based on any other team statistic which could be data mined, e.g. within baseball is well-known to gather innumerable statistics from the game, and within other games statistics can be based on things like who has possession of the ball and where is the ball located.

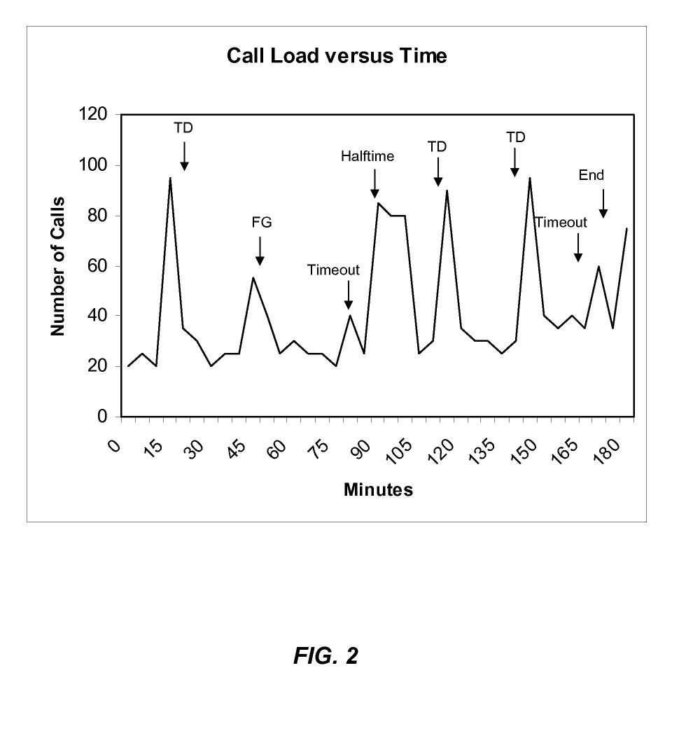

FIG. 2 provides a graph that illustrates the number of calls made at particular times during a football game, where “TD” indicates a touchdown and “FG” indicates a field goal. As can be seen, there are large demand spikes after every event change, such as a touchdown and field goal, as well as a demand spike during halftime and timeouts.

Referring back to FIG. 1, the at least one base station 104 is operable to preemptively change access parameters and/or modify the services available in proximity to the event in order to accommodate an increased load due to the status change. For example the base station can bar some high bit rate services, e.g. only use half rate voice service, for short time interval after the status change of the event, or can reconfiguring voice channels for text messaging for the short time interval. The exact time interval may be different for different events, e.g., scoring specific, and can even be dynamically changed to suit the demand spike. In practice, the present invention would utilize a half rate vocoder that would include a minimum and maximum load threshold parameters associated with vocoder bit rate determination. These load thresholds could also be dynamically changed to suit demand spikes.

Alternatively or additionally, the network can handover calls to other base stations neighboring the stadium, where possible. In another option, the network can reduce lower priority service and increasing higher priority service for a predetermined period, wherein users paying a higher premium will get preferred treatment at sporting events. Optionally, the base station 104 can train itself using actual observed communication traffic with corresponding game events in order to better serve calls in future events while meeting communication capacity. For example, the system could be trained by gathering statistics on event inputs, and then correlating them with the experience traffic on a historical basis to determine the best predictors for causality. This information can also be used to estimate the amount of venture capacity needed for future stadium events in those cases where the demand spikes still can not be accommodated by the above described techniques, in order to drive decisions about the number of base station to which should be used at the stadium for particular events.

It is also desirable to minimize that amount of paging which occurs inside the stadium during the game, where the number of RF registrations/paging zone registrations mobiles need to perform consumes capacity and battery life. Therefore, the present invention envisions using normal large paging zones prior to the game actually starting, but after the game starts, the paging zone which overlaps the stadium is shrunk so that it only covers the stadium. This will not cause any additional registrations within the stadium itself, but users that were originally in the same zone as the stadium, will now be in the new paging zone and will need to perform a registration. Just prior to the game finishing, the paging zone covering the stadium is expanded to include the larger original area covered by that paging area. This technique avoids lots of registrations inside the stadium at the start of the game, while also avoiding sending pages in the stadium for users which are outside of the stadium.

In a preferred embodiment, the base station communicates any service changes to a mobile device, warning a user about a change or lack of service availability before the user can place a call that might result in a busy signal. This can lessen the number of RF registrations/paging zone registrations mobile devices need to perform, which can reduce capacity even further, not to mention battery life of the mobile devices.

The present invention also describes a method for managing localized, event-generated overload of a communication network. A first step 400 includes receiving input indicative of a status change of an event, such as in a sports arena or stadium. Such input can include; a change in score, a change in player position(s), a time out, a change of possession, an increased noise level, and the like, for example. Preferably, the input also indicates that there will be an upcoming status change of the event, such as a half-time period, for example.

A next step 402 includes generating an output to the communication network indicating that loading of the communication could be increasing in response to the status change.

A next step 404 includes predicting an increased load due to the status change and comparing 406 this against a threshold that can be determined empirically by the network operator. Preferably, the threshold can be dynamically changed to accommodate changing call demand. If the predicted load is not greater than the threshold, then the method can resume monitoring 400 for status changes. However, if the predicted load is greater than the threshold, then the network will take the next step.

A next step 408 includes modifying the services available in geographic proximity to the event for a predetermined period in order to accommodate the increased load due to the status change. Preferably, this step includes reducing a vocoder bit rate for new calls for a predetermined period, in order to handle more calls during that period. Additionally, this step can include reducing network access for lower priority service and increasing network access for higher priority service for a predetermined period. In addition, this step can include reconfiguring voice channels for text messaging for a predetermined period. Moreover, this step can include barring higher bit rate services and allowing lower bit rate services for new calls for the predetermined period. Also, this step can include handing off calls to cells neighboring the stadium for at least the predetermined period, all of which increase capacity. Further, this step can include a warning to a user about the upcoming change in service availability before the user can place a call.

Optionally, the method can include the further steps of inputting actual loading information resulting from the status change from the communication network, and using the actual loading information in predictions for loading.

Advantageously, the present invention results in a way to re-configure a network to increase call capacity to handle demand spikes by predicting when such spikes will occur and reducing high bit rate services before the calls causing such spikes can be placed. It is estimated that the present invention enables about 80% of calls during loading spiked to use half rate vocoder, as opposed to about 20% without the invention, resulting in a 1.4× higher effective voice capacity.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for managing localized event generated overload of a communication network, the method comprising the steps of:
receiving input indicating a status change of an event;
generating an output to the communication network indicating that loading of the communication will be increasing in response to the status change; and
modifying the services available in geographic proximity to the event in order to accommodate an increased load due to the status change.

2. The method of claim 1, further comprising the steps of:
inputting actual loading information resulting from the status change from the communication network; and
using the actual loading information in predictions for loading.

3. The method of claim 1, wherein the receiving step includes an event in a sports stadium.

4. The method of claim 3, wherein the input of the receiving step includes one of the group of; a change in score, a change in player position(s), a time out, a change of possession, and an increased noise level.

5. The method of claim 1, wherein the input also indicates that there will be an upcoming status change of the event.

6. The method of claim 1, wherein the modifying step reduces a bit rate for new calls for a predetermined period.

7. The method of claim 1, wherein the modifying step bars higher bit rate services and allows lower bit rate services for new calls for a predetermined period.

8. The method of claim 1, wherein the modifying step includes warning a user about an upcoming change in service availability before the user can place a call.

9. The method of claim 1, wherein the modifying step includes reducing network access for lower priority service and increasing network access for higher priority service for a predetermined period.

10. The method of claim 1, wherein the modifying step includes reconfiguring voice channels for text messaging for a predetermined period.

11. A method for managing localized event generated overload of a communication network, the method comprising the steps of:
receiving input indicative of a status change of an event in a sports stadium;
generating an output to the communication network indicating that loading of the communication could be increasing in response to the status change;
comparing a predicted increased load due to the status change against a threshold; and
modifying the services available in proximity to the stadium for a predetermined period in order to accommodate the increased load due to the status change.

12. The method of claim 11, further comprising the steps of:
inputting actual loading information resulting from the status change from the communication network; and
using the actual loading information in predictions for loading.

13. The method of claim 11, wherein the modifying step reduces a vocoder bit rate for new calls for the predetermined period.

14. The method of claim 11, wherein the modifying step bars higher bit rate services and allows lower bit rate services for new calls for the predetermined period.

15. The method of claim 11, wherein the modifying step includes warning a user about service availability before the user can place a call.

16. The method of claim 11, wherein the modifying step includes reducing lower priority service and increasing higher priority service for the predetermined period.

17. The method of claim 11, wherein the modifying step includes reconfiguring voice channels for text messaging for the predetermined period.

18. The method of claim 11, wherein the modifying step includes handing off calls to cells neighboring the stadium for at least the predetermined period.

19. The method of claim 11, wherein the comparing step includes dynamically changing the threshold to accommodate changing call demand.

20. A system for managing localized event generated overload of a communication network, the system comprising:
an event monitor operable to receive input indicating a status change of an event and generate an output to the communication network indicating that loading of the communication will be increasing in response to the status change; and
at least one base station servicing the area of the event, the at least one base station operable to modify the services available in proximity to the event in order to accommodate an increased load due to the status change.
